(19) United States
(12) Patent Application Publication
(10) Pub. No.: US 2006/0044248 A1
(43) Pub. Date: Mar. 2, 2006

(54) Display panel driving circuit

(76) Inventor: Katsuhiko Maki, Chino-shi (JP)

Correspondence Address: HARNESS, DICKEY & PIERCE, P.L.C., P.O. BOX 828, BLOOMFIELD HILLS, MI, 48303, US

(21) Appl. No.: 11/175,954

(22) Filed: Jul. 6, 2005

(30) Foreign Application Priority Data
Aug. 30, 2004 (JP) 2004-249677

(51) Int. Cl. G09G 3/36

(52) U.S. Cl. 345/98

(57) ABSTRACT

A display panel driving circuit including: a memory temporarily storing input image data; a controller controlling reading operation of the image data for each line from the memory in order that a line number for starting display is changed every predetermined number of a frame period on a display panel; and an image signal supplying unit converting the image data for each line, which are sequentially read out from the memory, into a plurality of analog image signals and supplying the image signals to the display panel.

### BACKGROUND OF THE INVENTION

1. Technical Field

The invention relates to a display panel driving circuit for driving a display panel. In particular, it relates to a display panel driving circuit for driving a liquid crystal display panel (LCD) including a plurality of thin film transistors (TFTs).

2. Related Art

A LCD including a plurality of TFTs is connected to a display panel driving circuit for driving a source of TFTs (a source driver) and a display panel driving circuit for driving a gate of TFTs (a gate driver). The source driver converts the image data sequentially read from random access memory (RAM) fro each line into analogue data and supplies them to the source of TFTs.

Meanwhile, the gate driver generates a gate potential which turns on TFTs on a sequentially selected line and supplies the potential to the gate of TFTs. Further, it generates the common potential Vcom which is applied to the second electrode (referred to as the common electrode hereafter), which opposes to a plurality of first electrodes (referred to as dot electrodes)driven by TFTs. When the gate driver continues to apply DC voltage to LCD panel, the characteristics of a liquid crystal is deteriorated. The common potential Vcom is inverted every specific period.

In general, this inverting methods include a line inverting method of inverting the common potential Vcom every one line and a frame inverting method of inverting the common potential Vcom every one frame (or one field). One of them is applied. The line inverting method shows high image quality, but high power consumption. Therefore, it is desirable that the frame inverting method is applied with improving image quality.

Here, a problem of image quality, when the frame inverting method is applied, is explained. FIG. 5 shows a schematic diagram including a power source circuit in the source driver and a common potential output circuit in the gate driver. The power source circuit in the source driver includes a stabilizing circuit 1, which stabilizes the source potential V_{DD} and generates the source potential VCOMH, a boosting circuit 2, which boosts voltage based on the source voltage V_{DD} and V_{SS} so as to generate the source potential VCOMW and a boosting circuit 3, which boosts voltage based on the source potential VCOMH and V_{SS} so as to generate the source potential VCOML. For example, the values of the source voltage V_{DD} and V_{SS} are 3V and 0V respectively. The values of the source potential VCOMW, VCOMH and VCOML are 5V, 2.5V and −2.5V respectively.

The boosting circuit 3 comprises a N channel MOS transistor QN1, P channel MOS transistors QP1 to QP3 and capacitors C1 and C2. The gate of these transistors receives clock signals HN1 and HP1 to HP3 shown in FIG. 6 and are repeatedly turned off and on during a state S1 or S2. This repetition changes the potentials at the nodes A, B and C for boosting operation.

The source potential VCOMH and the source potential VCOML are applied to the common potential output circuit 4 in the gate driver to generate the common potential Vcom. The common potential output circuit 4 is an inverter comprising a N channel MOS transistor QN2, a P channel MOS transistor QP4 and generates the common potential Vcom by inverting an input potential Vin.

FIG. 7 shows the states of charging and discharging in the capacitors C1 and C2. In the state S1 shown in FIG. 7A, the capacitor C1 is charged, but one end (the node C) of the capacitor C2 is disconnected from the node B so that the source potential VCOML has to be hold with charges stored in the capacitor C2. Meanwhile, in the state S2 shown in FIG. 7B, one end (the node C) is connected to the node B so that the source potential VCOML can be hold with charges stored in the capacitors C1 and C2. However, the capacitance of the capacitors is limited so that it become difficult to maintain the source potential VCOML, particularly in the state of S1.

Here, there is a leak current in the LCD panel so that current is flown between the common electrode and other potential electrodes even after the common electrode potential reaches high level or low level. A period of one frame is about 16.7 seconds, relatively longer. This period yields a problem of difficulty in maintaining the common voltage VCOM constant.

FIG. 8 shows a waveform of the common voltage Vcom outputting from the gate driver. The source potential VCOMH regulating a high level of the common potential Vcom is stabilized so as not to fluctuate the common voltage Vcom during a one frame period, in which the common voltage Vcom is a high level. On the other hand, the source potential VCOML regulating a low level of the common potential Vcom is not stabilized so as to fluctuate the common voltage Vcom during another frame period, in which the common voltage Vcom is a low level.

FIG. 9 shows an image displayed by the conventional panel driving circuit on a LCD panel. When the common potential Vcom fluctuates described above and even an image data showing a uniform a gray image is input, there is phenomenon in which an image becomes brighter in the lower portion of the image. It is desirable to solve such image deterioration under the frame inverting method.

With respect to related technology, FIG. 1 on the first page of the Japanese non examined published patent 5-8846 discloses a matrix driving method in which an image quality is improved by avoiding flickering in a flat type display having bi-stable ferroelectric's liquid crystal, which displays a gray scale image by equi-divided shrunken frame scanning method.

In this matrix driving method, when displaying 2N gray scales, the frame period Tf is divided into N pieces of fields and image data are written for all scanning lines within a field. Further, all scanning lines are divided into a plurality of groups and a signal is reset within in each group after time which corresponds a gray scale 2n (n=0, 1, . . . N−1). Each of groups is scanned with interlaced approach in order to avoid overlapping periods in which an image has the same gray scale within a group.

This method prevents flickering so as to improve an image quality. On the other hand, the problem in the frame inverting method of a LCD panel explained above is uneven brightness within a frame, not flickering.

### SUMMARY

The present invention is intended to provide a display panel driving method reducing uneven brightness within a frame with applying a frame inverting method, which shows small power consumption for driving a display panel.

According to an aspect of the invention, a display panel driving method comprises memory temporarily storing input image data; a controller controlling reading operation of the image data for each line from the memory in order that a number of a line for starting display is changed every predetermined numbers of a frame period; and an image signal supplying unit converting the image data for each line, which are sequentially read out from the memory, into a plurality of analog image signals and supplying the image signals to the display panel.

Further, the controller may include a counter counting a signal synchronized with a frame period and outputting the count value; and an address-generating unit generating an address, which corresponds to the image data for each line read out from the memory based on the signal synchronized with a line display period and the count value output from the counter.

The display panel may be a liquid display panel. The image signal supplying unit may supply the plurality of image signals to a source of a plurality of thin film transistor (TFTs), which drives a plurality of first electrodes for each line of the liquid crystal panel. Further, the address-generating unit may generate a gate driver control signal for controlling a gate driver that applies a gate potential to a plurality of gates of TFTs, which drive a plurality of first electrodes for each line, in order that a plurality of lines for the liquid crystal panel is driven with a predetermined order. Further, the gate driver may invert a common potential, which is supplied to a second electrode that opposites to the plurality of first electrodes for each line of the liquid crystal panel with a predetermined order, every one frame or one field period.

According to the invention, reading out an image data is operated so as differentiate a number of a line for starting display every predetermined number of a frame period, providing a display panel driving method reducing uneven brightness within a frame with applying a frame inverting method, which shows small power consumption for driving a display panel.

### BRIEF DESCRIPTION OF THE DRAWINGS

The invention will be described with reference to the accompanying drawings, wherein like numbers refer to like elements, and wherein:

FIG. 1 shows connection between a display panel driving circuits of the present embodiment and a display.

FIG. 2 shows a part of a source driver and a LCD panel shown in FIG. 1

FIG. 3 shows an order of lines displayed during each frame period.

FIG. 4 shows an image yielded by the display panel driving circuits of the present embodiment.

FIG. 5 shows a power source circuit in a source driver.

FIG. 6 shows waveforms of clock signals used in the boosting circuit shown in FIG. 5

FIGS. 7A and 7B show states of charging and discharging of capacitors.

FIG. 8 shows a waveform of the common voltage Vcom outputting from the gate driver.

FIG. 9 shows an image displayed by the conventional panel driving circuit on a LCD panel.

### DESCRIPTION OF THE EMBODIMENTS

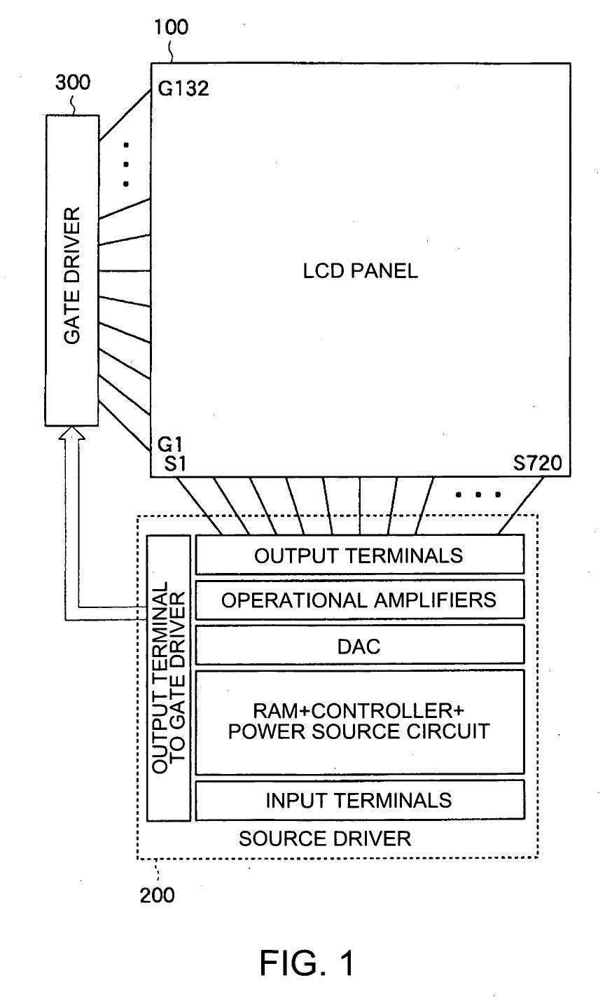

Embodiments of the invention will now be described with reference to the accompanying drawings. In the embodiments, a display panel is a liquid display panel. FIG. 1 shows connection between a LCD panel and a display panel driving circuit of the embodiment. A LCD panel 100 includes TFTs, which are arranged in a matrix corresponding to 720×132 dots pixels, for example. In order to drive the LCD panel 100, a display panel driving circuit (a source driver) 200 for driving sources of TFTs is connected to a source lines S1 to S720 and a display panel driving circuit (a gate driver) 300 for driving sources of TFTs is connected to a gate lines G1 to G132.

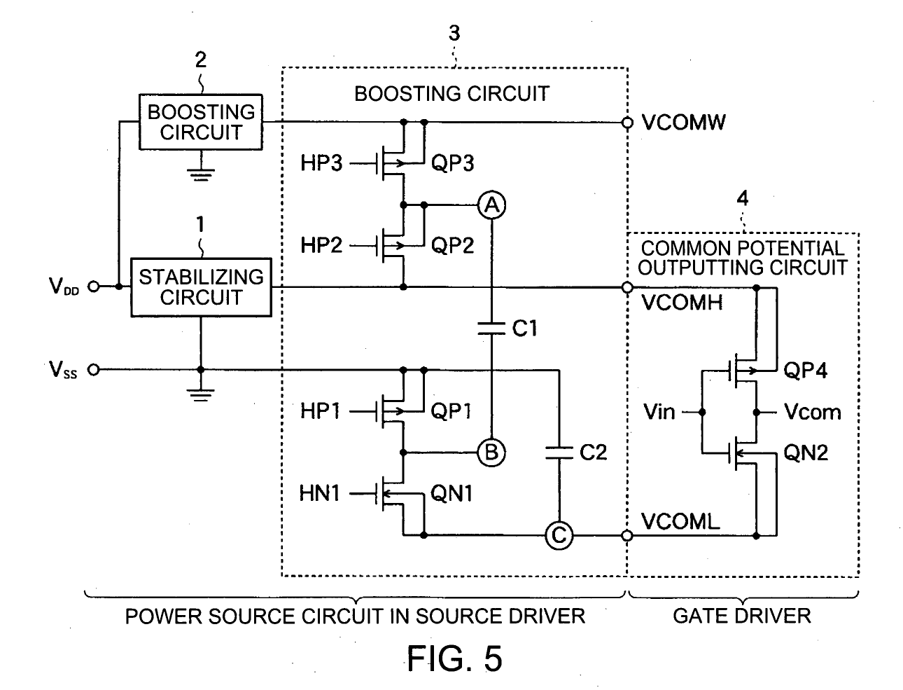

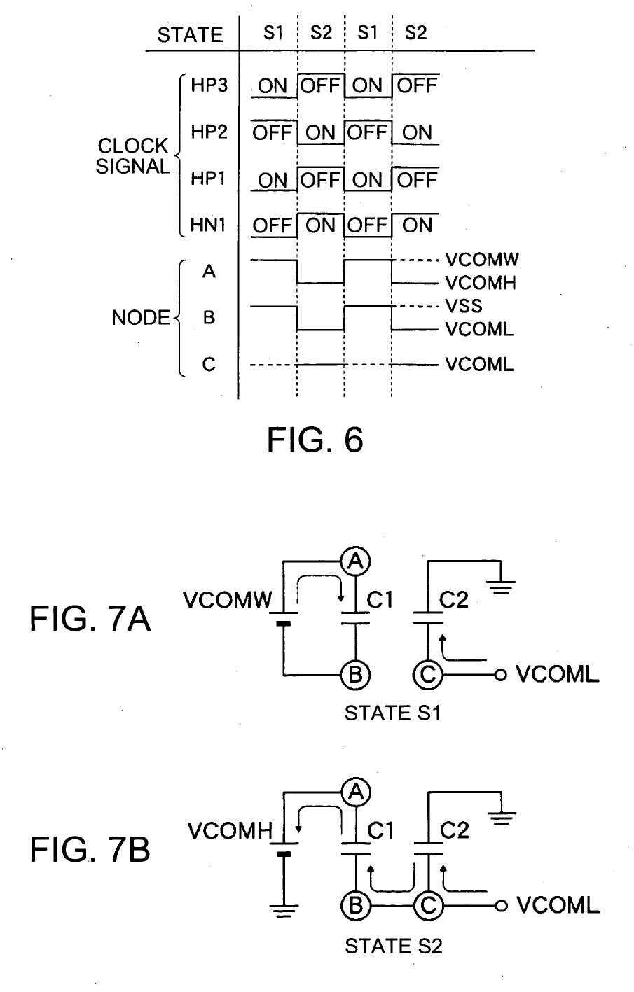

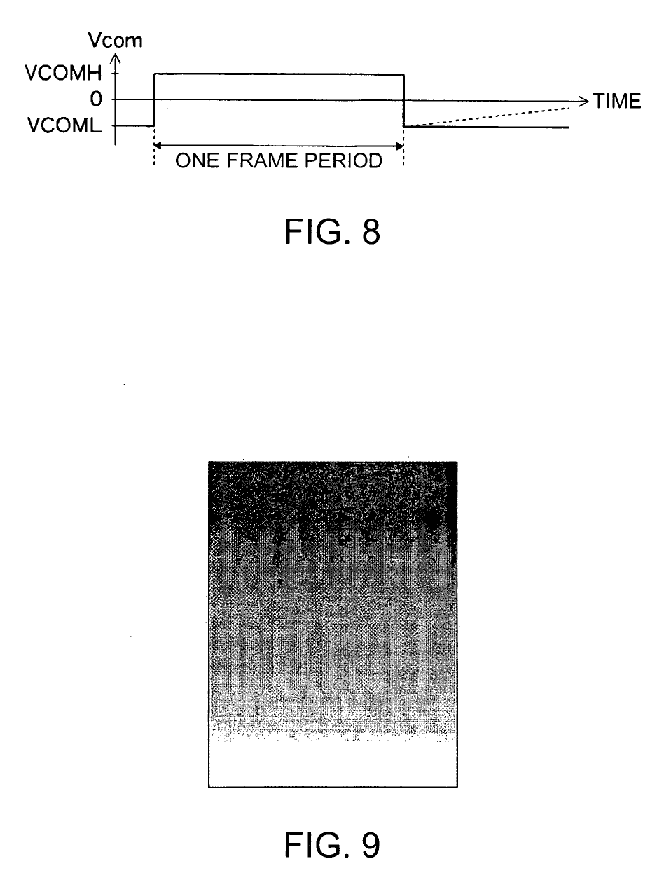

The source driver 200 mainly comprises a RAM, a controller, a power source circuit, a digital to analog converter (DAC) an operational amplifier, input and output terminals and output terminals of a gate driver. The gate driver 300 uses the frame inverting method already explained on FIG. 5 to FIG. 9, in which the common potential Vcom is inverted every predetermined number of a frame period and sequentially supplied to a plurality of common electrodes.

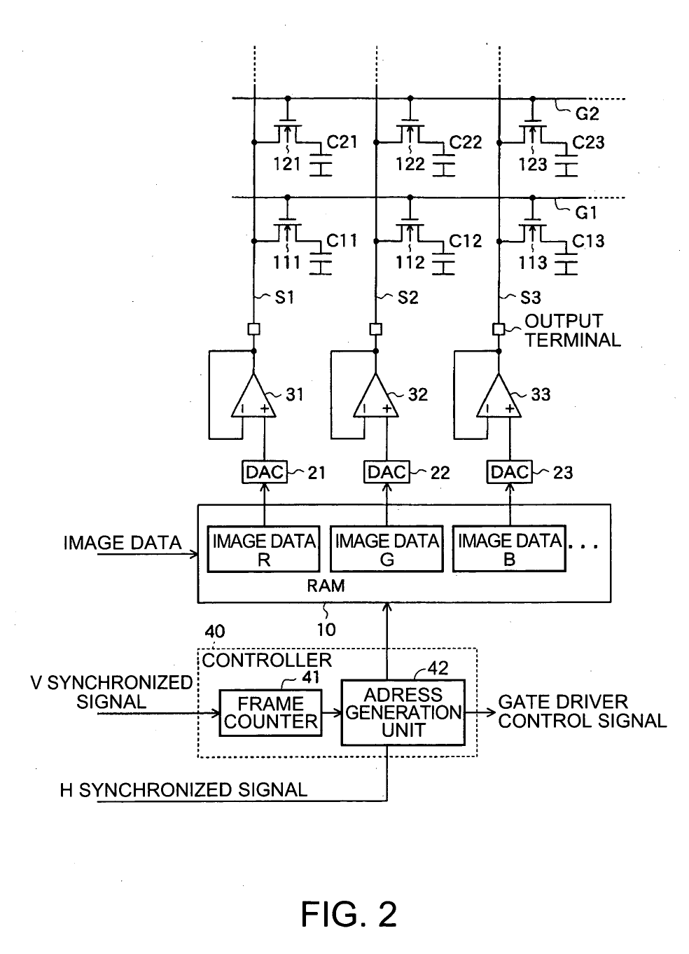

FIG. 2 shows a part of the source driver and the LCD panel shown in FIG. 1. The source driver comprises a RAM 10 temporarily storing red (R), green (G) and blue (B) image data, DACs 21, 22 and 23 converting three kinds RGB image data for each line sequentially read out from the RAM 10 into analog image data, operational amplifiers 31, 32 and 33 amplifying image signals outputting from DACs and a controller controlling reading out image data from the RAM 10.

Image signals for each line amplified by the operational amplifiers 31, 32 and 33 are applied to a source line S1 of TFTs 111, 121 . . . driving the first column's dot electrodes, a source line S2 of TFTs 112, 122 . . . driving the second column's dot electrodes and a source line S3 of TFTs 113, 123 . . . driving the third column's dot electrodes in the LCD panel. Further, capacitors C11, C21 . . . represent capacitances between the drain of TFTs 111, 121 . . . and dot electrodes of the LCD panel.

Image signals for each line amplified by the operational amplifiers 31, 32 and 33 are applied to a source line S1 of TFTs 111, 121 . . . driving the first column's dot electrodes, a source line S2 of TFTs 112, 122 . . . driving the second column's dot electrodes and a source line S3 of TFTs 113, 123 . . . driving the third column's dot electrodes in the LCD panel. Further, capacitors C11, C21 . . . represent capacitances between the drain of TFTs 111, 121 . . . and dot electrodes of the LCD panel. The controller 40 includes a frame counter 41 and address-generating unit 42 and changes the order of driving a plurality of lines of the LCD panel so as to differentiate a number of a line for starting display on the LCD panel.

Here, the frame counter 41 counts the vertical (V) synchronized signal synchronized with one frame period and generates counted values to output them to the address-generating unit 42. Further, the address counting unit 42 generates these counted values and address for image data for each line read out from the RAM 10 based on horizontal (H) synchronized signals synchronized with a line display period. Further, it generates a gate driver control signal for controlling the gate driver 300 shown in FIG. 1. Here, if a counted value becomes the predetermined value in the frame counter 41, the count value is reset.

Image data read out from the RAM 10 are converted into analog image signals by DACs 21, 22, 23 . . . . Here, each of the DACs 21, 22, 23 . . . is a resistant circuit network type DAC using a plurality of resistances, in which resistant values of resistances are set having gamma correction characteristics, can convert the input image data into image signals, compensated with gamma correction.

Analog image signals outputting from DACs 21, 22, 23 . . . are input to the operational amplifiers 31, 32 33, . . . to be amplified. The image signals outputting from the operational amplifiers 31, 32 33, . . . are supplied to source lines S1, S2, S3 . . . of the LCD panel via a plurality of output terminals.

Image signals applied to the source line S1 are also applied to sources of TFTs 111, 121, image signals applied to the source line S2 are also applied to sources of TFTs 112, 122 and image signals applied to the source line S3 are also applied to sources of TFTs 113, 123.

Meanwhile, the gate driver 300 sequentially selects each of lines corresponding to the image signals applied to the LCDS panel 100 from the source driver 200 based on the gate drover control signal supplied from the source driver 200. Further, it supplies a high level gate signal to selected one of the gate lines G1, G2 . . . and also supplies the common potential Vcom to selected one of a plurality of common electrodes. Of a plurality of TFTs connected to one source line, TFTs of which gate lines are a high level are turned on so as to supply image signals to dot electrodes connected to TFTs via capacitances. Thus, a line for starting display is changed every predetermined numbers of frame periods to display image data on the LCD panel 100.

Conventionally, a line for starting display was the same in any frame period. For example, the first line initially is displayed, next the second line is displayed and the 132nd line is finally displayed in any frame periods. On the other hand, a line for starting display is changed every predetermined numbers of frame periods in the embodiment.

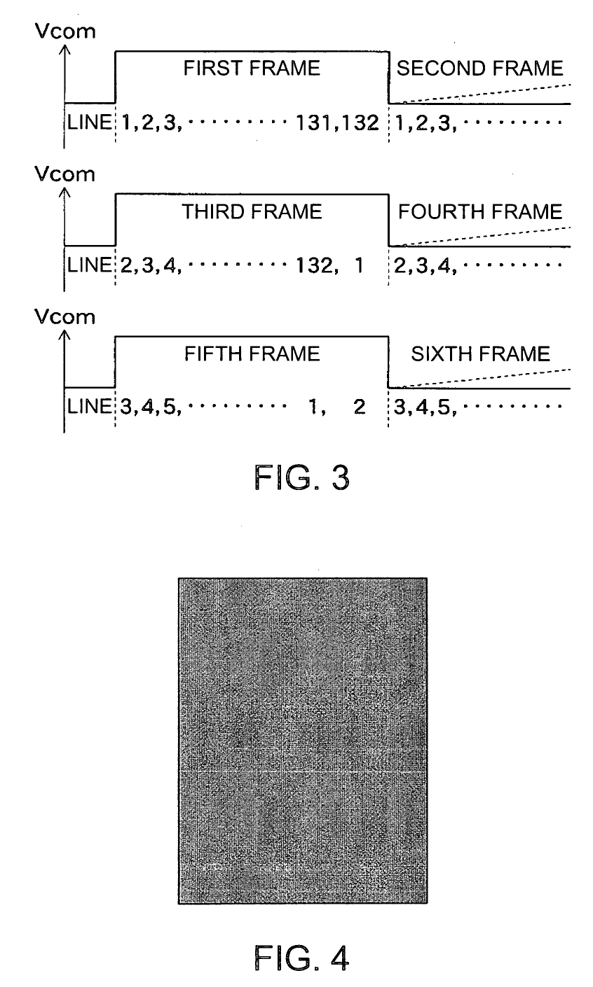

As shown in FIG. 3, during the first and second frame periods, the first line initially is displayed, next the second line is displayed and the 132nd line is finally displayed. On the other hand, during the third and fourth frame periods, the second line initially is displayed, next the third line is displayed and the first line is finally displayed. Furthermore, during the fifth and sixth frame periods, the third line initially is displayed, next the fourth line is displayed and the second line is finally displayed.

FIG. 4 shows an image displayed by a panel driving circuit of the embodiment on a LCD panel. Here, image data showing uniform gray image are inputs to a source driver. An order of displaying a plurality of lines is changed in a display panel so that uneven brightness during one frame can be reduced by visually integrating changes of brightness for each line, even the common voltage Vcom fluctuates during one frame as shown in FIG. 3. Uneven brightness caused by other factors during a frame period can be also reduced.

Otherwise, the counted value obtained by counting V synchronized signal via the frame counter 41 shown FIG. 2 may be used as a number of a line for starting a display in the frame. Thus, during the first frame period, the first line initially is displayed, next the second line is displayed and the 132nd line is finally displayed. Further, during the second frame period, the second line initially is displayed, next the third line is displayed and the first line is finally displayed. Further, during the third frame period, the second line initially is displayed, next the third line is displayed and the first line is finally displayed.

When interlace scanning method, which constitutes one frame by a planarity of fields, is applied, the common potential Vcom is inverted every one field. In such case, the order of displaying a plurality of lines on a display panel is implemented as the following:

For example, in case of one frame comprising three fields, during the first field period of the first frame, the first line initially is displayed, next the fourth line is displayed and the 130th line is finally displayed. Further, during the second field period, the second line initially is displayed, next the fifth line is displayed and the 131st line is finally displayed. Further, during the third field period, the third line initially is displayed, next the sixth line is displayed and the 132nd line is finally displayed.

Further, during the first field period of the second frame, the fourth line initially is displayed, next the seventh line is displayed and the first line is finally displayed. Further, during the second field period, the fifth line initially is displayed, next the eighth line is displayed and the second line is finally displayed. Further, during the third field period, the 6th line initially is displayed, next the 9th line is displayed and the third line is finally displayed.

According to the present embodiment, even in a non interlace scanning method or an interlace scanning method, uneven brightness during one frame can be reduced with using frame inverting method, which has small power consumption.

What is claimed is:

1. A display panel driving circuit comprising:
a memory temporarily storing input image data;
a controller controlling reading operation of the image data for each line from the memory in order that a line number for starting display is changed every predetermined number of a frame period on a display panel; and
an image signal supplying unit converting the image data for each line, which are sequentially read out from the memory, into a plurality of analog image signals and supplying the image signals to the display panel.

2. A display panel driving circuit according to claim 1, wherein the controller includes; an counter counting a signal synchronized with a frame period and outputting the count value; and an address-generating unit generating an address, which corresponds to the image data for each line read out from the memory based on the signal synchronized with a line display period and the count value outputting from the counter.

3. A display panel driving circuit according to claim 1, wherein the display panel is a liquid display panel.

4. A display panel driving circuit according to claim 3, wherein the image signal supplying unit supplies the plurality of image signals to a source of a plurality of thin film transistor (TFTs), which drives a plurality of first electrodes for each line of the liquid crystal panel.

5. A display panel driving circuit according to claim 4, wherein the address-generating unit generates a gate driver control signal for controlling a gate driver that applies a gate potential to a plurality of gates of TFTs, which drive a plurality of first electrodes for each line, in order that a plurality of lines for the liquid crystal panel is driven with a predetermined order.

6. A display panel driving circuit according to claim 5, wherein the gate driver inverts a common potential, which is supplied to a second electrode that opposites to the plurality of first electrodes for each line of the liquid crystal panel with a predetermined order, every one frame or one field period.
